(19) United States
(12) Patent Application Publication
(10) Pub. No.: US 2009/0074389 A1
(43) Pub. Date: Mar. 19, 2009

(54) HEATER DEVICE AND RELATED METHOD FOR GENERATING HEAT

(75) Inventors: Nathan H. Noe, Calabasas, CA (US); David A. Boyd, Pasadena, CA (US); Richard M. Cox, Thousand Oaks, CA (US)

Correspondence Address: KELLY LOWRY & KELLEY, LLP, 6320 CANOGA AVENUE, SUITE 1650, WOODLAND HILLS, CA, 91367, US

(73) Assignee: LEXINGTON ENVIRONMENTAL TECHNOLOGIES, INC., Mesa, AZ (US)

(21) Appl. No.: 12/249,391

(22) Filed: Oct. 10, 2008

Related U.S. Application Data
(63) Continuation-in-part of application No. 11/420,187, filed on May 24, 2006.
(60) Provisional application No. 60/979,581, filed on Oct. 12, 2007.
(60) Provisional application No. 60/981,042, filed on Oct. 18, 2007.
(60) Provisional application No. 60/684,919, filed on May 25, 2005.

(51) Int. Cl. H05B 3/60

(52) U.S. Cl. 392/314

(57) ABSTRACT

A method for generating heat includes passing a liquid between electrodes connected to an alternating current power supply. The liquid must have a sufficient level of electrolytes or dissolved minerals so as to be effectively heated. The level of current applied to the electrodes is preferably monitored and controlled. Exothermic, electrochemical reactions occur within the liquid and at the surface of the electrodes. More particularly, the electrodes are comprised of a material that can be oxidized, and the oxidation process during operation of the heater supplies additional current to heat the liquid.

### BACKGROUND OF THE INVENTION

The present invention generally relates to heaters. More particularly, the present invention relates to a method for rapidly and efficiently generating heat, typically in a liquid having electrolytes therein and passing between oxidizable electrodes.

Heating systems are commonly employed to provide occupants of a building suitable living and working temperatures. Several forms of heaters are known, including for example, resistive electric heat, natural gas furnaces, oil furnaces and the like. In some instances, heated air is then pumped through the building. In other instances, hydronic heating systems are used. In such systems, water is typically heated by an oil or natural gas furnace and the water is pumped through a closed system, typically within the floor of the building or area to be heated. Not only the floor, but also a space above the floor is heated by radiant heat emitted from the heated water running in the closed loop system below the floor.

These heating systems have their disadvantages. They typically require either a fairly large amount of electricity, or the burning of fossil fuels which can be expensive and also which emit undesirable byproducts. Hydronic heating systems generally rely on a central hot water supply and insulation of pipes, which adds construction expenses. Such hydronic heating systems typically share the home plumbing hot water supply, and can deplete the water available for showers and other applications.

Diathermal heating devices are known. For example, U.S. Pat. No. 3,641,302 to Sargeant discloses an apparatus for treating liquids with high-frequency electrical energy. Sargeant discloses that the high-frequency electrical energy or field pervades and fills all the space between electrodes, hence the liquid is subjected to the action of this energy once it passes between the electrodes causing it to be heated. More recently, U.S. Pat. No. 5,506,391 to Burayez et al. disclose a liquid heater using electrical oscillations. Similar to Sargeant, Burayez et al. disclose that the electrical oscillations, and not the passage of current, are used to generate the heat. Burayez et al. teach the use of a control circuit for controlling the source and amplitude of the electrical oscillations used to heat the water. The power supply is modulated by an oscillator circuit connected to a thermal sensor. A microprocessor takes the thermal readings and controls the modulated power supply.

However, the inventor has discovered that, in fact, the level or modulation of the oscillations is not critical to the performance of the diathermal heater. Instead, it has been discovered that the heat produced by the diathermal heater is directly related to the amount of current input into the heater. The amount of current that can be input into the heater is somewhat dependent upon the level of electrolytes, typically in the form of dissolved solids, such as dissolved mineral salts, present in the liquid. Moreover, it has been found that if the electrolyte liquid is passed between electrodes which are of a metal or alloy which can be oxidized, the process of oxidation creates energy and electrons so as to reduce the amount of current that would otherwise need to be input to heat the liquid to the desired level.

### SUMMARY OF THE INVENTION

The present invention is directed to a method of generating heat, and a related heating device, in which electrolyte liquid is passed between oxidizable electrodes which have an alternating current applied thereto so as to heat the liquid.

The method for generating heat, in accordance with the present invention, comprises providing a first electrode comprised of an oxidizable and conductive material, and a second electrode also comprised of an oxidizable and conductive material. The first and second electrodes are in spaced relation to one another. An aqueous fluid containing a sufficiently high level of dissolved salts or minerals to conduct electricity therethrough is also provided, and passed between the first and second electrodes. An electrochemical reaction is generated when the aqueous fluid is passed between the first and second electrodes which have an alternating current supply thereto. The first and second electrodes are oxidized and dissolved salts or minerals in the aqueous solution are exhausted, resulting in an increase of temperature or current supplied to the aqueous fluid in excess to that created by the passing of the current through the aqueous fluid between the electrodes such that the amount of current that would otherwise need to be input to heat the liquid or fluid to the desired level is reduced.

In a particularly preferred embodiment, the temperature of the aqueous fluid is monitored. The level of current applied to the electrodes is reduced if the temperature exceeds a predetermined level. Alternatively, the current applied to the electrodes is increased if the temperature falls below a predetermined level.

The amount of current drawn into the electrodes can also be monitored. Current phase control circuits are used to maintain the current applied to the electrode within a predetermined range. The level of current applied to the electrodes is reduced if the current drawn by the electrodes exceeds a predetermined level. This can occur if the level of dissolved salts or minerals in the aqueous fluid is high. Conversely, the current applied to the electrodes can be increased if the current drawn by the electrodes is determined to fall below a predetermined level. This can occur if the level of dissolved salts or minerals in the aqueous fluid is low. An alarm, in the form of an audible or visual alarm, can be activated if the monitor current level drawn by the electrodes is too low, so as to notify the owner of the heating device of the need to replenish the level of dissolved salts or minerals in the aqueous fluid, or replace the aqueous fluid which has had its dissolved salts or minerals exhausted over time.

The method for generating heat of the present invention, in a particularly preferred embodiment, is embodied in a heater device. The heater device comprises an alternating current power supply. A heater module is operably connected to the power supply. The heater module comprises a first electrode comprised of an oxidizable conductive material, and a second electrode in spaced relation to the first electrode and comprised of an oxidizable conductive material. A fluid passageway is defined by a fluid inlet, the space between the first and second electrodes, and a fluid outlet. A supply of aqueous fluid having a sufficient level of dissolved salts or minerals so as to be sufficiently conductive to pass current between the first and second electrodes is provided. The heater device also includes a pump for moving the aqueous fluid through the heater module and to a heat exchanger. The application of current to the electrodes, while in the presence of the aqueous fluid, causes an electrochemical reaction that generates current or heat in excess of the heat or current generated by passing the applied current between the electrodes, thus reducing the amount of current applied to the electrodes to heat the aqueous fluid to a predetermined level.

The first and second electrodes are typically comprised of a metal, which includes an oxidizable material such as iron. In one embodiment, the first and second electrodes are comprised of a stainless steel. Preferably, the heater module is removably attached to the heater device so as to be replaceable with a new heater module after the electrodes have been oxidized to a predetermined level.

Typically, the heater device includes a sensor adapted to detect the temperature of the aqueous fluid or the amount of current supplied to the heater module. An electronic circuit is operably associated with the sensor and adapted to automatically shut off or reduce the alternating current supplied to the heater module when the sensed temperature exceeds a predetermined level, or to automatically supply alternating current to the heater module when the sensed temperature is below a predetermined level. Preferably, the electronic circuit includes a current limiter which is operably associated with the sensor for increasing the current applied to the heater module when the detected temperature or the current falls below a predetermined level, or decreasing the current applied to the heater module when the detected temperature or the current exceeds a predetermined level.

In a particularly preferred embodiment, the heater device includes a visual or audible alarm operably connected to the sensor and activated when the detected temperature or the current falls outside of a predetermined range, so as to notify the owner of the heater device of the need to replenish the level of dissolved salts or minerals in the aqueous solution, or the need to replace the heater module.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a cross-sectional diagrammatic view of a diathermal heater system having concentric electrodes, in accordance with the present invention;

FIG. 2 is a cross-sectional diagrammatic view of yet another heating system having parallel electrodes, in accordance with the present invention;

FIG. 3 is a cross-sectional diagrammatic view of another heater having an alternating array of electrodes, in accordance with the present invention;

FIG. 4 is a diagrammatic view of a closed loop heating system incorporating a heat exchanger device;

FIG. 5 is an electronic schematic illustrating power and control circuitry used in accordance with the heating system of FIG. 4;

FIG. 6 is an electronic schematic of a current limiter, used in accordance with the present invention;

FIG. 7 is a perspective view of a heater module, used in accordance with the present invention; and

FIG. 8 is a cross-sectional view of the heater module taken generally along line 8-8 of FIG. 7.

### DETAILED DESCRIPTION OF THE PREFERRED EMBODIMENTS

As shown in the accompanying drawings, for purposes of illustration, the present invention resides in a heater device and a related method for heating a liquid. In accordance with the present invention, as will be described more fully herein, the present invention resides in the control of a series of non-equilibrium, exothermic, electrochemical reactions. More particularly, as will be more fully described below, the present invention resides in a method for heating a liquid. In a particularly preferred embodiment, the liquid is passed between metal electrodes having an alternating current supplied thereto. The fluid is typically an aqueous solution having sufficient electrolytes, such as salts and minerals, so as to sufficiently conduct electricity to be heated. For example, distilled water is very difficult to heat using the invention. However, water which has sufficient electrolytes in the form of minerals, salts, etc., such as tap water having sufficient mineral content, is readily heated using the present invention. In fact, in accordance with the present invention, the aqueous solution is heated more rapidly and to a greater degree given the current input. It is believed that this occurs due to the various exothermic, electrochemical reactions occurring in the electrodes and/or the electrolytes/minerals of the water solution. The present invention is also directed to a current limiter device for limiting the alternating current which is applied to the heater in order that it does not overheat or produce more heat or energy than is desired.

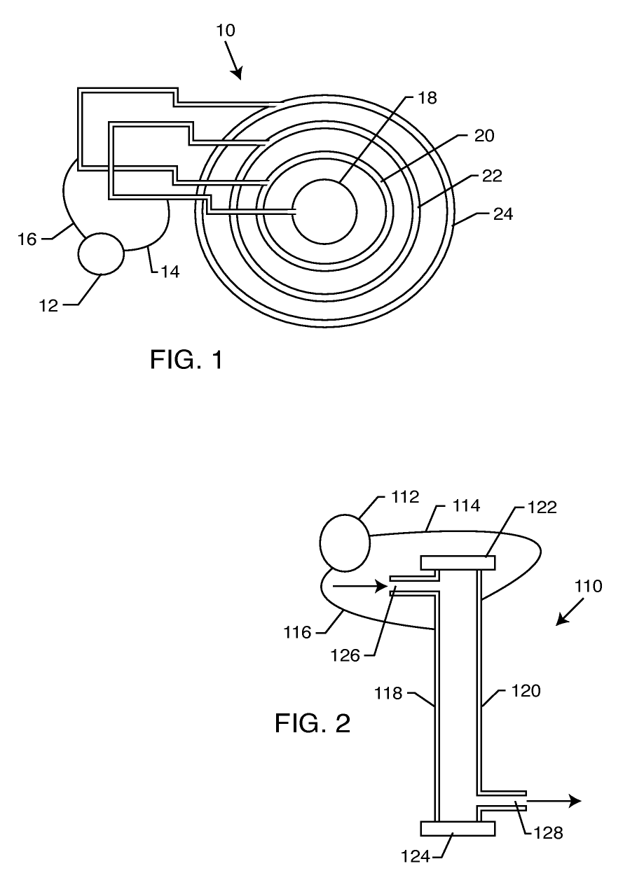

With reference now to FIG. 1, a diagrammatic view of an exemplary heater device 10 embodying the present invention is shown. The heater device 10 includes a power source 28 supplies electricity in the form of an alternating current. Although the frequency and voltage of the power supply is not critical, the power supply is typically taken from a wall outlet or a generator so as to provide between 100 and 500 volts at approximately 60 Hz. More typically, the power supply is either 110 volts or 220 volts at 60 Hz. As will be more fully described below, the level of current is controlled so as to not overheat the liquid.

Electrical leads 14 and 16 supply the alternating current to concentric electrodes 18-24. The aqueous solution flows between these electrodes 18-24. As current is applied to a first set of electrodes 18 and 22, charge accumulates on the electrodes during one portion of the alternating current cycle. The same charge is removed from the other electrodes 20 and 24 to any other portion of the alternating current cycle. The passage of the current through the aqueous fluid heats the aqueous fluid. As indicated above, the aqueous fluid must contain a sufficiently high level of dissolved salts or minerals or the like so as to conduct the current in the electricity between the electrodes 18-24.

The electrodes 18-24 are comprised of a conductive metal material which can be oxidized. For example, the metal material may include iron (Fe). It is believed that as the electrode material is oxidized, electrons are released to the electrode. In the case of iron, this can be the removal of two or three electrons per oxidized molecule of iron. The result is the creation of excess charge on the electrode surface during the portion of the alternating current cycle as current enters the electrode. This excess charge is then removed during the other portion of the alternating current cycle. The flow of this charge from the electrode surface adds to the total current, and in effect, acts as an additional current source. For a given voltage, this oxidation generated current reduces the amount of current that needs to be supplied by the external power source 12 for a given power input necessary to heat the aqueous solution to a desired level.

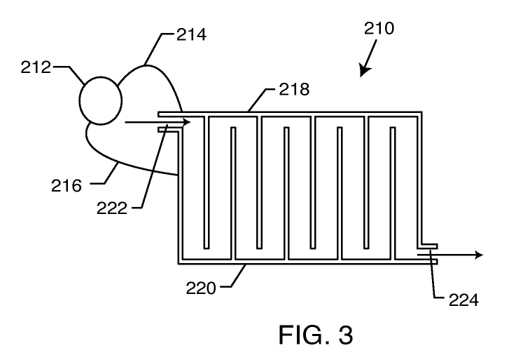

With reference now to FIGS. 2 and 3, it will be appreciated by those skilled in the art that the electrode arrangement is not limited to that illustrated in FIG. 1. As illustrated in FIG. 2, a heater device 110 embodying the present invention does have an alternating current power supply 112 with positive and negative leads 114 and 116 extending into conductive contact with parallel electrodes 118 and 120. The electrodes 118 and 120 are comprised of a conductive and oxidizable material, such as a metal including iron, stainless steel, etc. In this case, end caps 122 and 124 are comprised of an insulating material, such that electricity does not flow between the electrodes 118 and 120, other than when the aqueous fluid is passed therebetween, through inlets 126 and out outlet 128. When the dissolved salt or mineral content of the aqueous fluid is sufficiently high, current is able to pass between the electrodes 118 and 120, resulting in exothermic chemical reactions which oxidize the electrodes 118 and 120 and exhaust the dissolved salt and mineral content of the fluid over time.

With reference now to FIG. 3, yet another heater module and heater device 210 of the present invention is illustrated which also includes an alternating current power supply 212 and electrical leads 214 and 216 for supplying the alternating current to separated first and second electrodes 218 and 220, which in this embodiment form an alternating array of electrodes forming a fluid passageway between an inlet 222 and an outlet 224 thereof. Passage of the current through the aqueous fluid heats the fluid. Moreover, as explained above, the exothermic chemical reactions also generate heat and/or additional electrons and thus current which further increases the temperature of the aqueous fluid. Thus, in order to achieve a predetermined level or desired temperature, the exothermic chemical reaction requires less current input into the electrodes.

Thus, it will be appreciated by those skilled in the art that the arrangement of the electrodes is not critical, so long as the current can pass through the liquid and the liquid contains a sufficient level of dissolved solids so as to be efficiently heated.

Heat is generated when the electrode is oxidized, as well as when the alternating current passes through the liquid which contains the electrolytes. The inventors have discovered that dissolved solids, such as minerals and other impurities in the liquid, are susceptible to electrical oscillations or current and cause the liquid to heat rapidly so that the liquid is hot as it emerges from the heating chamber. Liquid having a very low dissolved mineral content does not heat efficiently. For example, when distilled water is passed through the heating chamber, it is very difficult to heat the distilled water. However, when water is passed through the heating chamber which has a relatively high dissolved mineral content, the water can be heated very efficiently and to fairly high temperatures.

Tests have been conducted in order to confirm this phenomena. A closed-loop system holding 26 ounces of fluid, water having dissolved minerals or solids therein, has been passed through the heating chamber 10 using alternating current power supplied from a wall outlet and run for 80 minutes. The input power had a voltage of 220 volts, providing approximately 32 amps. The water was analyzed before being heated for 80 minutes, and after being heated for 80 minutes, as shown in Table 1.

TABLE 1
Dissolved Elements (mg/l) using SS electrodes

| Element | After | Before |
|---|---|---|
| Calcium | 21 | 30 |
| Chromium | 1.0 | <0.05 |
| Copper | 1.6 | <0.05 |
| Iron | .12 | <0.05 |
| Lead | 0.33 | <0.005 |
| Magnesium | 11 | 16 |
| Manganese | 0.50 | <0.05 |
| Molybdenum | 0.064 | <0.05 |
| Nickel | 1.9 | <0.05 |
| Zinc | 0.40 | <0.05 |

Stainless steel (SS) electrodes were used in a configuration similar to that shown in FIG. 1. After 80 minutes of operation, the levels of Ca and Mg were reduced, and there was an increase in metals associated with the stainless steel electrodes, namely, Fe, Cr, Ni, and Mn. The pH of the solution increased from 8.8 to 9.3, and the conductance decreased from 510 to 460 microsemens. It is believed that the driving mechanism for the excess heat is created by a series of non-equilibrium, exothermic, chemical reactions which take place on the electrodes. It is believed that the electrolytic mineral compounds (herein referred to as dissolved solids) in the water or other liquid and the electrode material react to form metal hydroxides. The formation of metal hydroxides is supported by the increase in pH. The water in the aqueous solution also is believed to play a part in creating the metal hydroxides, and in oxidizing the electrode metal. It might also be that the dissolved mineral compounds and/or salts in the liquid serve as catalysts for the oxidation of the metal electrodes.

This experiment was repeated, but using iron electrodes instead of the stainless steel electrodes. The before and after measured dissolved elements in the water are shown in Table 2.

TABLE 2
Dissolved Elements (mg/l) using iron electrodes.

| Element | After | Before |
|---|---|---|
| Calcium | 18 | 30 |
| Chromium | <0.05 | <0.05 |
| Copper | <0.05 | <0.05 |
| Iron | 0.13 | <0.05 |
| Lead | 0.15 | <0.005 |
| Magnesium | 8.1 | 16 |
| Manganese | 0.50 | <0.05 |
| Molybdenum | <0.05 | <0.05 |
| Nickel | <0.05 | <0.05 |
| Zinc | 0.070 | <0.05 |

Once again, the dissolved solid minerals (calcium and magnesium) were depleted significantly. An increase in the metals associated with the electrodes also increased. In this case, the amount of iron and lead increased significantly, but the levels of chromium and other heavy metals associated with the 304 stainless steel electrodes remained the same. From the above, it appears that there is an electrochemical reaction occurring at the surface, or within, the electrodes such that the electrodes are sloughing metallic compounds, and in particular iron and lead compounds. This is believed to occur through the process of oxidation, wherein heat is generated when the electrode is oxidized as well as when the alternating current passes through the liquid which contains the dissolved solids/electrolytes. In either case, due to the fact that current is generated by the oxidation of the electrode, this reduces the total amount of current that would otherwise be needed to heat the liquid at the same rate.

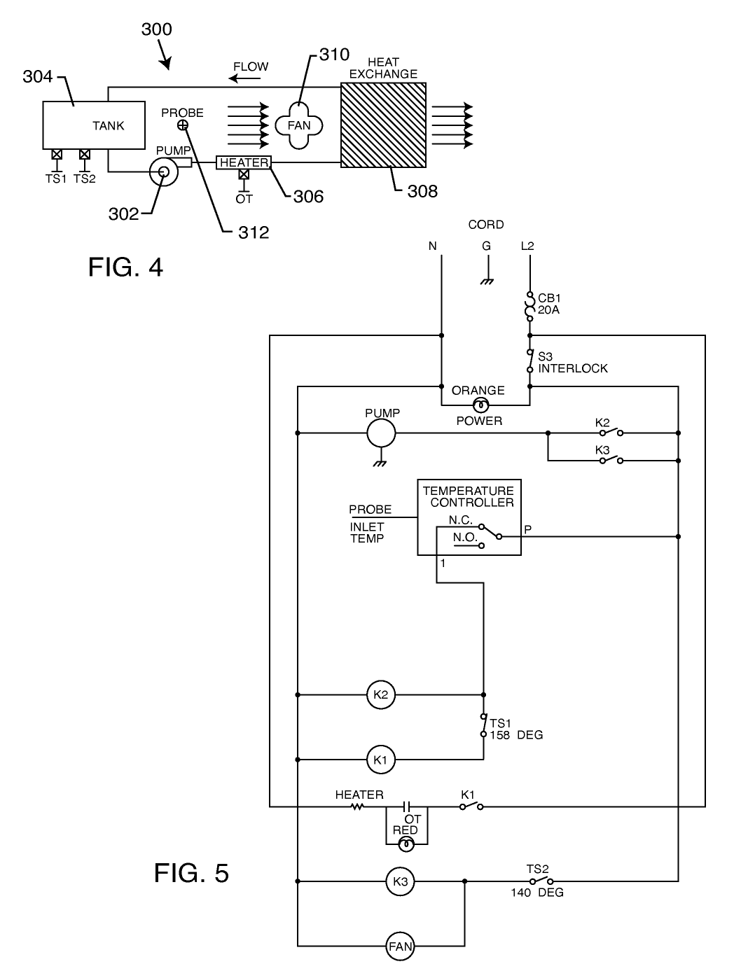

With reference now to FIG. 4, a closed system, self-contained heater device 300 is illustrated, wherein the pump 302 circulates aqueous fluid from a tank 304 through the heating chamber 306 and a heat exchanger 308. A fan or the like 310 forces air past the heat exchanger 308 so as to heat ambient air. A temperature probe 312 is used to monitor the temperature of the air or fluid. This embodiment is particularly adapted for portable heaters and in-wall heaters and the like which heat the ambient air in the space immediately in front of or surrounding the unit.

With reference to FIG. 5, incoming power from the cords N, G, L2 is routed to at least one circuit breaker CB2. At least one interlock switch is preferably incorporated such that when the cover of the heater device is removed, power to the control circuitry is disconnected. An indictor light can be incorporated to signify that the power is connected, as illustrated by the “orange power” or other color indicator light.

A temperature controller is used to adjust the amount of heat to be supplied by the unit to heat ambient air. Typically, the temperature controller has a range of forty to eighty degrees Fahrenheit, or the target ambient air temperature, and is the main user control mounted on the front panel, such as by a rotary dial or the like. When the controller is turned fully off, the controller will typically heat to protect the unit from damage from freezing. When the temperature drops below a setpoint, the red indicator light, an optional hour meter (not shown), and controller relay K2 are energized. Thermal switch TS1 is normally closed until the fluid temperature reaches a predetermined level, such as 150 degrees Fahrenheit. While it is closed, the heating element is energized and begins to heat the fluid. Controlled relay K2 turns on the pump to circulate the fluid from the storage tank 304, through the heater 306 and through the heat exchanger 308. When the fluid reaches a predetermined level, such as 140 degrees Fahrenheit, the temperature switch TS2 turns on the fan 310 and energizes controlled relay K3. The unit is now in heating mode, with the heating chamber 306, circulating pump 302, all operating. Temperature switch TS1 controls the heating chamber electrodes, and maintains the fluid at a predetermined temperature, typically 158 degrees Fahrenheit.

When the air temperature reaches the desired temperature, as set by the temperature controller, which may be linked to a thermostat, the red indicator light, optional hour meter, and control relay K2 are de-energized. The pump 302 and fan 310 typically will remain on until the temperature switch TS1 opens as the water temperature falls below the preset level, typically 140 degrees Fahrenheit. At that time, the pump 302 and fan 310 are shut off and the unit is no longer providing heat. When the air temperature falls below the selected temperature, the system will again become energized and the fluid heated until the air temperature is raised to the desired level.

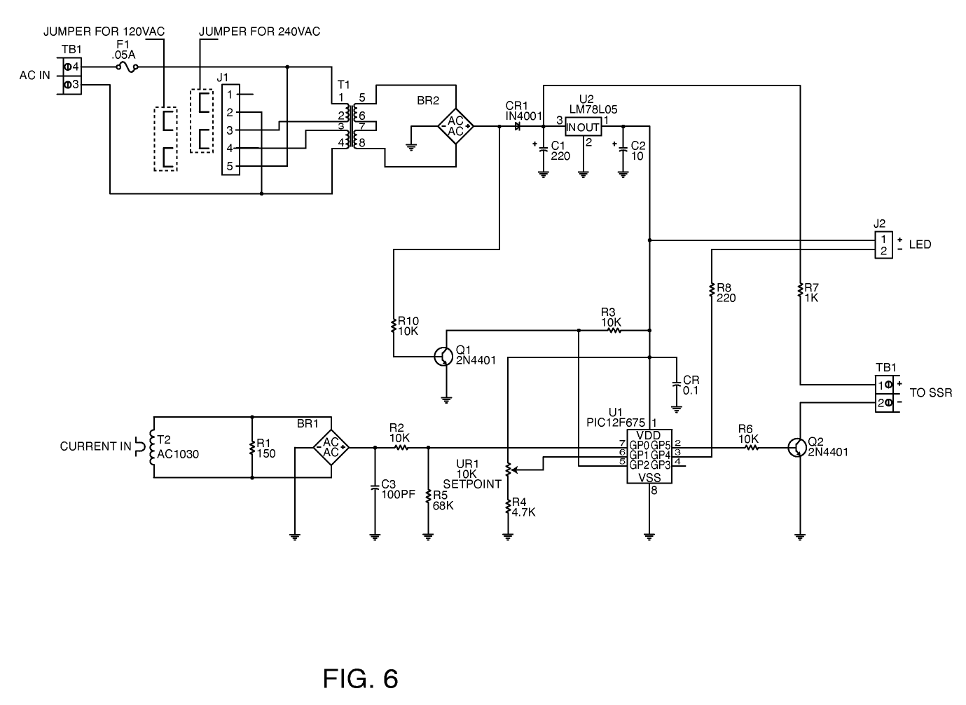

It has been found that when a sufficiently high level of dissolved solids are within the fluid, the electrodes and fluid pull in a higher level of current than when the level of dissolved solids is lower. Although the dissolved solid content in the aqueous fluid must meet a minimum threshold, there are instances when the dissolved mineral content within the fluid is too high. In such instance, the system will naturally pull in a large amount of current and heat the fluid to a very high temperature. In such cases, this is controlled in a variety of ways. For example, the power source may be coupled to a current limiter such that the amount of power, more particularly current, that is input into the electrodes is limited. An electronic circuit for an exemplary current limiter used in accordance with the present invention is illustrated in FIG. 6. In another embodiment, the temperature of the fluid is monitored, and the power input into the system is shut off when the temperature of the fluid exceeds a predetermined level. The fluid can also be cooled, such as by using fans or the like, to control the heating process. Such steps may be required when the dissolved solid content of the aqueous fluid is too high, such as very hard water or adding too much salt or concentrated dissolved minerals to the fluid.

As mentioned above, when the dissolved mineral content within the fluid is high, the system will naturally pull in a large amount of current and heat the fluid to a very high temperature, possibly overheating the heater device, or creating more heat than is desired. For example, in the heater device disclosed above, tap water in various parts of the United States has such a high mineral content that the tap water was not able to be used as it would heat excessively. Thus, the methodology identified above in providing an aqueous fluid with a controlled amount of mineral content was devised. However, it would be preferable to use existing water sources instead of supplying specialized water having a pre-set and monitored mineral content, which increases complexity and cost at both the manufacturing and operation levels.

It has been discovered that the heater device of the present invention can use existing water sources, such as tap water, with varying levels of mineral content by implementing a current limiter device or electronic circuit, as illustrated in FIG. 6 which is particularly adapted and suited for use with the heater device of the present invention. The current limiter device is designed to limit the alternating current (AC) of the heater module to a preset value. The amount of current allowed can be variable, if a variable switch is incorporated into the circuit. Briefly, the current limiter measures the AC current (typically 120V or 220V) delivered to the heater, and controls the phase of a triac-based solid state relay.

With reference now to FIG. 6, an electronic schematic of the current limiter or controlling device is illustrated. Incoming line voltage, either 120 volt or 240 volt is applied to TBI 3 and 4. An on-board jumper is factory installed to connect the power transformer secondaries in either series (240V) or parallel (120V). The secondary voltage is rectified, filtered and regulated to 5 volts DC for the microcontroller circuit. A connection directly to the bridge rectifier BR2 is applied to transistor Q1 to provide a zero-crossing reference. This pulse is applied to the microcontroller U1.

Current transformer T2 has a hole through its core, through which passes the wire which supplies power to the heater. The current transformer output is loaded by R1, which translates the current output to a scaled voltage. This voltage is rectified by BR1 and divided down to a suitable voltage, then applied to an analog input on the microcontroller. A second analog input is connected to a setpoint potentiometer VR1.

The microcontroller integrates the measured AC current over each half cycle of the 60 Hz line and calculates the average current, and compares it to the setpoint. It then outputs a signal timed to the zero crossing to transistor Q2, which supplies an on/off control to the external solid state relay which is, in turn, connected in series with the heater. This control signal adjusts the turn-on time of the SSR. If the measured current is low, the control signal is output earlier in the cycle, and if the current is high, it is output later. As described above, the electronic device monitors the current, and chops the level of electrical current to the desired level, such that the heater outputs a desired amount of heat and the aqueous solution is heated to a desired level. This process is known as phase control.

If the control signal is timed to provide maximum output to the heater, but the measured current is still too low, a panel mounted LED, or other visual or audible alarm, connected to J2 is turned on. This notifies the user that more chemicals or minerals need to be added to the water tank in the heater. For example, there are areas of the United States where the mineral content of tap water is very low, and minerals, such as described above, will need to be added to the water so as to create sufficient current pull and heating. The visual or audible alarm may also notify the owner of the heater device that the heater module, and specifically the electrodes have been oxidized to the point where they need to be replaced. Alternatively, the heater device may include a timer such that after a certain predetermined period of time of usage of the heater device, the user is notified of the need to replace the electrodes as they have been oxidized to a sufficient point where they need to be replaced for optimum efficiency of the heater device.

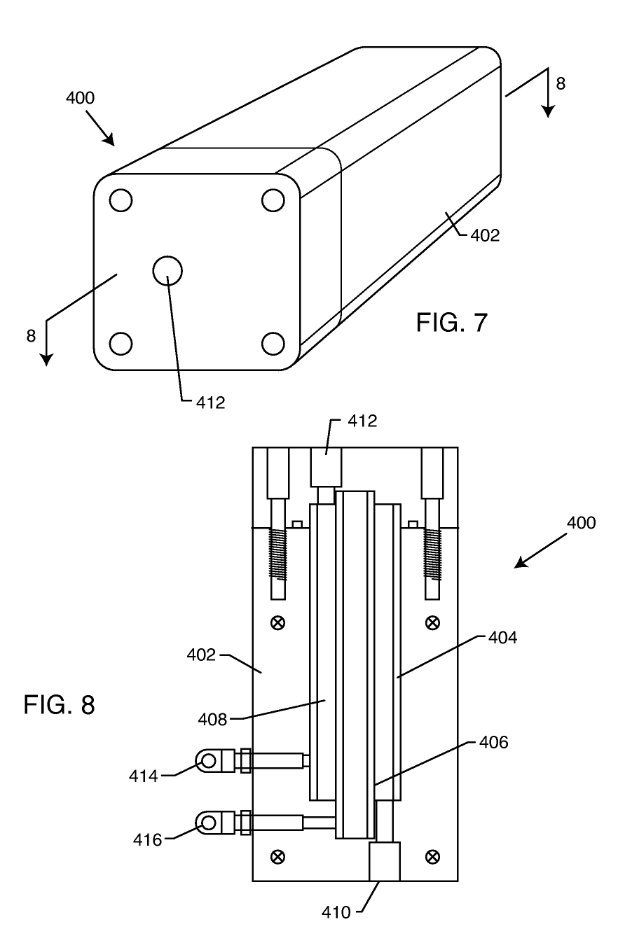

With reference now to FIGS. 7 and 8, as the electrodes in the heater of the heating device of the present invention are oxidized over time, there will inevitably be the need to replace the electrodes. Replenishment of the aqueous fluid is relatively easy by either inserting salts or minerals which dissolve into the fluid, replacing the aqueous fluid with tap water which has a sufficiently high mineral or salt content, or periodically replenishing or replacing the aqueous fluid with aqueous fluid which can be purchased for use with the heater device. However, the majority of prior art stand-alone and self-contained heater devices include a heating element which is incorporated integrally with the heater so as to be difficult, if not impossible, to replace by the end user. Replacement of the entire heating device of the present invention could be costly. In order to avoid this unnecessary cost, the present invention utilizes a removable heater module 400. The heater module is inserted and removed from the heater device similar to the manner in which one would insert or remove a battery from a flashlight.

With continuing reference to FIGS. 7 and 8, the heater module 400 includes a housing 402 into which are mounted the spaced apart first and second electrodes 404 and 406. As indicated above, the electrodes 404 and 406 are spaced apart from one another and electrically isolated, as needed, such as by insulative material other than a space defining a fluid passageway 408 therebetween. A fluid inlet 410 is adapted to receive a fluid conduit of the heater device. The aqueous fluid flows into the inlet 410 and through the fluid passageway 408 between the electrodes 404 and 406 before exiting the fluid outlet 412, which is also connected to the fluid conduit, similar to that illustrated in FIG. 4. Electrode contact 414 extends into conductive relationship with the first electrode 404. The second electrode contact 416 extends into electrical conductive connection to second electrode 406. The electrode contacts 414 and 416 are either moved into engagement with corresponding positive and negative electrodes operably associated with a power supply, such as by frictional contact, or by interconnecting them by means of conductive screws, sleeves, etc. as is known in the art. In this manner, the entire heating module 400 can be easily replaced instead of the need to remove the electrodes individually, which would require professional assistance, or the replacement of the entire heater device, which would be very expensive.

It will be appreciated by those skilled in the art that the heater device and method for generating heat described above have many potential uses. For example, the heater device can be used in home heating. This may be as a zone heating device, a built-in and forced air device, a stand-alone space heater, or as a boiler for floor-type radiant systems. The heater device of the present invention could also be used in association with residential and commercial water heaters. Given the relatively small size of the heater device, one or more heaters could be utilized such that heated water on demand could be implemented and the possibility of eliminating the piping for hot water, which is otherwise needed with existing gas or electric water heater devices. The heater device of the present invention could also be incorporated into dishwashers, washing machines, clothes dryers, coffee makers and the like.

The present invention could be implemented into a cold weather heat pump. The heater device could also be incorporated in use for commercial cooking operations. Other commercial applications include the provision of heat for chemical solutions during manufacture.

In many parts of the United States, an oil storage tank is used for winter heating and the like. The present invention could be used to heat the oil storage tank.

In yet another application, the present invention can be implemented in the recovery of oil. In certain oil wells, the oil is sufficiently embedded within the bedrock, or includes a sufficiently high level of parrafin or other types of substances so as to trap the oil within the bedrock. The present invention could be used to eject steam into an oil well, heating the oil and loosening it from the bedrock, and/or melting other such waxy substances or the like so as to enable the oil to be recovered underground. The heater device of the present invention produces a tremendous amount of heat and steam in a fairly small self-contained unit which could be easily delivered by a truck, or even truck-mounted. The heater device would need to have a sufficiently large quantity of aqueous fluid meeting the criteria indicated above so as to eject the steam into the oil wells. As indicated above, the tap water from many areas of the country has a sufficiently high level of dissolved salts or minerals to achieve this purpose. The heater device of the present invention could be plumbed to an existing water source, draw water or aqueous fluid from a drum or tank, or the like.

Although several embodiments have been described in detail for purposes of illustration, various modifications may be made to each without departing from the scope and spirit of the invention. Accordingly, the invention is not to be limited, except as by the appended claims.

What is claimed is:

1. A heater device, comprising:
an alternating current power supply;
a heater module operably connected to the power supply, the heater module comprising a first electrode comprised of an oxidizable conductive material, a second electrode in spaced relation to the first electrode and comprised of an oxidizable conductive material, a fluid passageway defined by a fluid inlet, the space between the first and second electrodes, and a fluid outlet;
a supply of aqueous fluid having a sufficient level of dissolved salts or minerals so as to be sufficiently conductive to pass current between the first and second electrodes; and
a pump for moving the aqueous fluid through the heater module;
wherein the application of current to the electrodes while in the presence of the aqueous fluid causes an electrochemical reaction that generates current or heat in excess of the heat or current generated by passing the applied current between the electrodes, reducing the amount of current applied to the electrodes to heat the aqueous fluid to a predetermined level.

2. The heater device of claim 1, wherein the heater module is removably attached to the heater device so as to be replaced with a new heater module after the electrodes have been oxidized to a predetermined level.

3. The heater device of claim 1, wherein the first and second electrodes are comprised of a metal including iron.

4. The heater device of claim 3, wherein the first and second electrodes are comprised of stainless steel.

5. The heater device of claim 1, including a sensor adapted to detect the temperature of the aqueous fluid or the amount of current supplied to the heater module.

6. The heater device of claim 5, including an electronic circuit operably associated with the sensor and adapted to automatically shut off or reduce the alternating current supplied to the heater module when the sensed temperature exceeds a predetermined level, or to automatically supply alternating current to the heater module when the sensed temperature is below a predetermined level.

7. The heater device of claim 5, including a current limiter operably associated with the sensor for increasing the current applied to the heater module when the detected temperature or the current falls below a predetermined level, or decreasing the current applied to the heater module when the detected temperature or the current exceeds a predetermined level.

8. The heater device of claim 5, including a visual or audible alarm operably connected to the sensor and activated when the detected temperature or the current falls outside of a predetermined range so as to notify of the need to replenish the level of dissolved salts or minerals in the aqueous solution or the need to replace the heater module.

9. The heater device of claim 1, wherein the pump moves heated aqueous fluid from the heater module to a heat exchanger.

10. A heater device, comprising:
an alternating current power supply;
a heater module operably connected to the power supply, the heater module comprising a first electrode comprised of an oxidizable conductive material, a second electrode in spaced relation to the anode and comprised of an oxidizable conductive material, a fluid passageway defined by a fluid inlet, the space between the first and second electrodes, and a fluid outlet;
a supply of aqueous fluid having a sufficient level of dissolved salts or minerals so as to be sufficiently conductive to pass current between the first and second electrodes; and
a pump for moving the aqueous fluid through the heater module and to a heat exchanger;
a sensor adapted to detect the temperature of the aqueous fluid or the amount of current supplied to the heater module;
a current limiter electronic circuit operably associated with the sensor and the power supply, and adapted to increase the current applied to the heater module when the detected temperature or the current falls below a predetermined level, or decreasing the current applied to the heater module when the detected temperature or the current exceeds a predetermined level;
wherein the application of current to the electrodes while in the presence of the aqueous fluid causes an electrochemical reaction that generates current or heat in excess of the heat generated by passing the applied current between the electrodes, reducing the amount of current applied to the electrodes to heat the aqueous fluid to a predetermined level.

11. The heater device of claim 10, wherein the heater module is removably attached to the heater device so as to be replaced with a new heater module after the electrodes have been oxidized to a predetermined level.

12. The heater device of claim 10, wherein the first and second electrodes are comprised of a metal including iron.

13. The heater device of claim 10, wherein the first and second electrodes are comprised of stainless steel.

14. The heater device of claim 10, including a visual or audible alarm operably connected to the sensor and activated when the detected temperature or the current falls outside of a predetermined range so as to notify of the need to replenish the level of dissolved salts or minerals in the aqueous solution or the need to replace the heater module.

15. A method for generating heat, comprising the steps of:
providing a first electrode comprised of an oxidizable and conductive material and a second electrode comprised of an oxidizable and conductive material in spaced relation to one another;
providing an aqueous fluid containing a sufficiently high level of dissolved salts or minerals to conduct electricity therethrough;
generating an electrochemical reaction by passing the aqueous fluid between the first and second electrodes and supplying an alternating current to the electrodes, wherein the first and second electrodes are oxidized and dissolved salts or minerals in the aqueous solution are exhausted, resulting in an increase of temperature or current supplied to the aqueous fluid in excess to that created by the passing of current through the aqueous fluid between the electrodes.

16. The method of claim 15, including the step of monitoring the temperature of the aqueous fluid.

17. The method of claim 16, including the step of reducing the level of current applied to the electrodes if the temperature exceeds a predetermined level, or increasing the current applied to the electrodes if the temperature is below a predetermined level.

18. The method of claim 15, including the step of monitoring the amount of current drawn into the electrodes.

19. The method of claim 18, including the step of using current phase control to maintain the current applied to the electrodes within a predetermined range.

20. The method of claim 19, including the step of reducing the level of current applied to the electrodes if the current drawn by the electrodes exceeds a predetermined level, or increasing the current applied to the electrodes if the current drawn by the electrodes is below a predetermined level.

21. The method of claim 18, including the step of activating an alarm if the monitored current level drawn by the electrodes is too low to notify of the need to replenish the level of dissolved salts or minerals in the aqueous fluid or replace the aqueous fluid.
